(19) United States
(12) Patent Application Publication
(10) Pub. No.: US 2026/0107174 A1
(43) Pub. Date: Apr. 16, 2026

(54) METHOD AND APPARATUS FOR QOE MEASUREMENT COLLECTION IN WIRELESS

(71) Applicant: Samsung Electronics Co., Ltd., Suwon-si, Gyeonggi-do (KR)

(72) Inventors: Hong WANG, Beijing (CN); Lixiang XU, Beijing (CN); Weiwei WANG, Beijing (CN)

(21) Appl. No.: 19/115,017

(22) PCT Filed: Sep. 26, 2023
(86) PCT No.: PCT/KR2023/014827

§ 371 Date: Mar. 25, 2025

(30) Foreign Application Priority Data
Sep. 26, 2022 (CN) 202211177543.1

(51) Int. Cl. H04W 24/10; H04W 76/27

(52) U.S. Cl. CPC H04W 24/10; H04W 76/27

(57) ABSTRACT

The present disclosure relates to a 5G communication system or a 6G communication system for supporting higher data rates beyond a 4G communication system such as long term evolution (LTE). The present disclosure provides a method and apparatus for Quality of Experience (QoE) measurement collection, wherein a method performed by a second node in a wireless communication network is disclosed, the method including: receiving a first message including configuration information for QMC from a first node, wherein the configuration information for QMC includes first indication information, wherein the first indication information indicates whether to perform a QoE measurement and/or whether to use configuration information for the QoE measurement already configured by a second node when a UE enters an idle mode or an inactive mode; and transmitting a second message including the first indication information to the UE.

### TECHNICAL FIELD

The present application relates to wireless communication technology, in particular to a method and device for Quality of Experience (QoE) measurement collection.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Solution to Problem

In a mobile communication system, more and more new services need to be supported, and a QoE measurement needs to be enhanced to optimize the network. For example, how to collect the QoE measurement, especially how to collect QoE measurement when a UE is in an RRC_INACTIVE or RRC_ IDLE state to optimize the network is an important direction worthy of study.

According to an embodiment of the present disclosure, a method performed by a second node in a wireless communication network is provided. The method including: receiving a first message including configuration information for QMC from a first node, wherein the configuration information for QMC includes first indication information, wherein the first indication information indicates whether to perform a QoE measurement and/or whether to use configuration information for the QoE measurement already configured by a second node when a UE enters an idle mode or an inactive mode; and transmitting a second message including the first indication information to the UE.

According to an embodiment of the present disclosure, the configuration information for QMC further includes one or more of following information:
a QoE reference;
a service type;
an area scope;
operator identifications;
an IP address of a Measurement Collector Entity (MCE);
a container for application layer measurement configuration;
a state of QoE measurement;
a matrix of QoE visible to RAN;
indication information for a QE measurement visible to RAN;
indication information about whether the second node needs to transmit a measurement result to the first node;
an RRC container;
a measurement configuration application layer identification;
configuration information of QoE-related control channels; and
a node type or node identification of the first node.

According to an embodiment of the present disclosure, the second message further includes one or more of following information:
a measurement configuration application layer identification;
a container for application layer measurement configuration;
an identification of an MBS service;
an area scope;
a QoE reference;
an RRC container;
configuration information of QoE-related control channels;
indication information for QoE measurement visible to RAN;
a matrix of QoE visible to RAN;
configuration information of QoE-related control channels;
a type of a base station, or identification of a base station, or related information of a base station;
an identification or identification-related information of an old serving cell or serving base station, or identification of the UE in the old serving cell;
indication information about whether the second node needs to transmit a measurement result to the first node;
second indication information, wherein the second indication information indicates whether the QoE measurement is a management-based QoE measurement or not, or indicates whether the QoE measurement is a management-based QoE measurement or a signaling-based QoE measurement;
information related to an MCE; and
a node type or node identification or node-related information.

According to embodiments of the present invention, a message including a QoE measurement report is received from the UE.

According to an embodiment of the present disclosure, if the QoE measurement is a management-based QoE measurement and the configuration information for QoE contains an identification of an MBS service, the configuration information for QoE is stored in a context of a UE that has joined the MBS service and is within an area scope; and/or
if it is configuration information for a signaling-based QoE measurement, the configuration information for the QoE measurement is stored in a context of a UE.

According to an embodiment of the present disclosure, the configuration information for QoE measurement used by UE in an RRC idle mode or inactive mode is the same as configuration information of the QoE measurement used by UE in an RRC connected mode.

According to an embodiment of the present disclosure, a third message transmitted by the UE to a third node includes at least one of following information:
information indicating whether a QoE measurement report exists;
information indicating whether signaling-based QoE measurement configuration exists;
whether an existing QoE measurement configuration is a management-based QoE measurement or a signaling-based QoE measurement.

According to an embodiment of the present disclosure, a fourth message transmitted to the UE by a third node requests the UE to report a QoE measurement report to the third node.
According to an embodiment of the present disclosure, a method performed by a UE in a wireless communication network is provided. The method including: receiving a second message including first indication information from a second node, wherein the first indication information indicates whether to perform a QoE measurement and/or whether to use configuration information for the QoE measurement already configured by a second node when a UE enters an idle mode or an inactive mode; and performing the QoE measurement.

According to an embodiments of the present disclosure, the method further includes transmitting a message containing a QoE measurement report to the second node.

According to an embodiments of the present disclosure, the message containing the QoE measurement report includes a measurement configuration application layer identification and a container, and the measurement result is included in the container.

According to an embodiment of the present disclosure, whether a target cell belongs to a measurement scope is determined based on the measurement scope of QoE and/or an operator identification.

According to an embodiment of the present disclosure, the method further includes transmitting a third message to a third node, wherein the third message includes at least one of following information:
information indicating whether a QoE measurement report exists;
information indicating whether signaling-based QoE measurement configuration exists;
whether an existing QoE measurement configuration is a management-based QoE measurement or a signaling-based QoE measurement.

According to an embodiment of the present disclosure, the method further includes receiving a fourth message from a third node, wherein the fourth message requests the UE to report a QoE measurement report to the third node.

According to an embodiment of the present disclosure, the method further includes receiving an RRC release request from a first base station to enter an RRC idle mode or an inactive mode.

According to an embodiment of the present disclosure, a node device in a wireless communication network is provided. The node device includes a transceiver; and a processor coupled to the transceiver and configured to perform the methods according to the above embodiments.

The present disclosure provides a method and device for Quality of Experience (QoE) measurement collection. The QoE measurement can be collected when the UE is in an RRC_INACTIVE or RRC_ IDLE state to optimize the network.

### BRIEF DESCRIPTION OF DRAWINGS

FIG. 1 is a system architecture diagram of system architecture evolution (SAE);

FIG. 2A is a schematic diagram of an initial overall architecture of 5G;

FIG. 2B is a schematic diagram of a gNB architecture;

FIG. 3 is a schematic diagram of an embodiment according to the present disclosure for QoE measurement collection;

FIG. 4 is a schematic diagram of an embodiment according to the present disclosure for QoE measurement collection;

FIG. 5 is a schematic diagram of an embodiment according to the present disclosure for QoE measurement collection;

FIG. 6 is a block diagram of a network node device according to an embodiment of the present disclosure; and

FIG. 7 is a block diagram of a UE according to an embodiment of the present disclosure.

### BEST MODE FOR CARRYING OUT THE INVENTION

In one embodiment, a method performed by a secondary node in a dual connectivity (DC) in a wireless communication network is provided. The method includes receiving, from an Operations, Administration and Maintenance (OAM), information for management-based quality of experience (QoE) configuration; selecting a user equipment (UE) performing at least one service type in the information for the management-based QoE configuration; and transmitting, to a master node in the DC, information for QoE measurement collection (QMC) configuration.

The method performed by the secondary node, wherein the information for QoE measurement collection (QMC) configuration includes at least one of: a QoE reference; and an Internet Protocol (IP) address of a Measurement Collector Entity (MCE).

The method performed by the secondary node, the method further comprising: identifying a higher layer identification (ID) associated with a QoE measurement configuration, wherein the higher layer ID associated with a measurement configuration is allocated by the master node.

In one embodiment, a secondary node in a dual connectivity (DC) in a wireless communication network is provided. The secondary node device includes a transceiver; and at least one processor configured to: receive, from an Operations, Administration and Maintenance (OAM), information for management-based quality of experience (QoE) configuration; select a user equipment (UE) performing at least one service type in the information for the management-based QoE configuration; and transmit, to a master node in the DC, information for QoE measurement collection (QMC) configuration.

The secondary node according to an embodiment, wherein the information for QoE measurement collection (QMC) configuration includes at least one of: a QoE reference; and an Internet Protocol (IP) address of a Measurement Collector Entity (MCE).

The secondary node according to an embodiment, the at least one processor further configured to: identify a higher layer identification (ID) associated with a QoE measurement configuration, wherein the higher layer ID associated with a measurement configuration is allocated by the master node.

In one embodiment, a method performed by a first node in a wireless communication network is provided. The method includes transmitting, to a second node, quality of experience (QoE) measurement configuration indicating a user equipment (UE) is allowed to continue QoE measurement in a Radio Resource Control (RRC) inactive state or in a RRC idle state; and continuing the QoE measurement collection (QMC) in the RRC inactive state or in the RRC idle state.

The method performed by the first node, wherein the QoE measurement configuration indicates a service type of the QoE measurement is a Multicast and Broadcast Services (MBS) broadcast.

In one embodiment, a first node in a wireless communication network is provided. The first node comprising: a transceiver; and the at least one processor configured to: transmit, to a second node, quality of experience (QoE) measurement configuration indicating a user equipment (UE) is allowed to continue QoE measurement in a Radio Resource Control (RRC) inactive state or in a RRC idle state, and continue the QoE measurement collection (QMC) in the RRC inactive state or in the RRC idle state.

The first node according to an embodiment, wherein the QoE measurement configuration indicates a service type of the QoE measurement is a Multicast and Broadcast Services (MBS) broadcast.

### Mode for the Invention

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

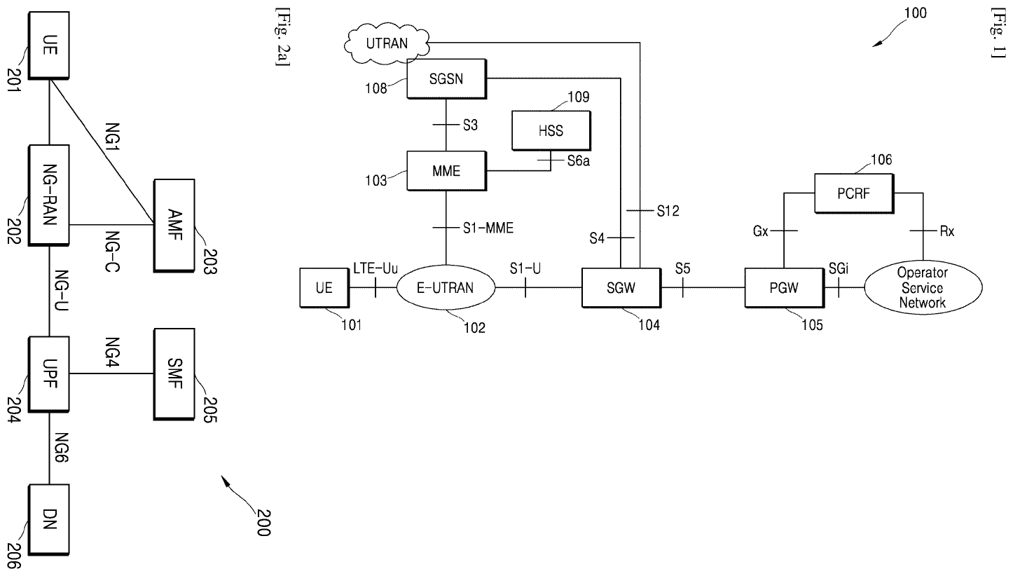

FIGS. 1 to 9 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

In order to make those of ordinary skill in the field better understand technical schemes of the present disclosure, the technical schemes in embodiments of the present disclosure will be described clearly and completely in connection with the drawings.

It should be noted that the terms “first” and “second” in the description and claims of the present disclosure and the above-mentioned drawings are used to distinguish similar objects, and are not necessarily used to describe a specific order or sequence. It should be understood that data used as this can be interchanged under appropriate circumstances, so that the embodiments of the present disclosure described herein can be implemented in other orders than those illustrated or described herein. Implementations described in the following embodiments do not represent all implementations consistent with the present disclosure. Rather, they are merely examples of apparatuses and methods consistent with some aspects of the present disclosure as detailed in the appended claims.

It should be noted herein that “at least one of several items” appearing in the present disclosure means containing the three juxtapositions: “any one of the several items”, “combination of any multiple items of the several items” and “all of the several items”. For example, “including at least one of A and B” includes the following three juxtapositions: (1) including A; (2) including B; and (3) including A and B. For another example, “performing at least one of Step 1 and Step 2” means the following three juxtapositions: (1) performing Step 1; (2) performing Step 2; and (3) performing Step 1 and Step 2.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

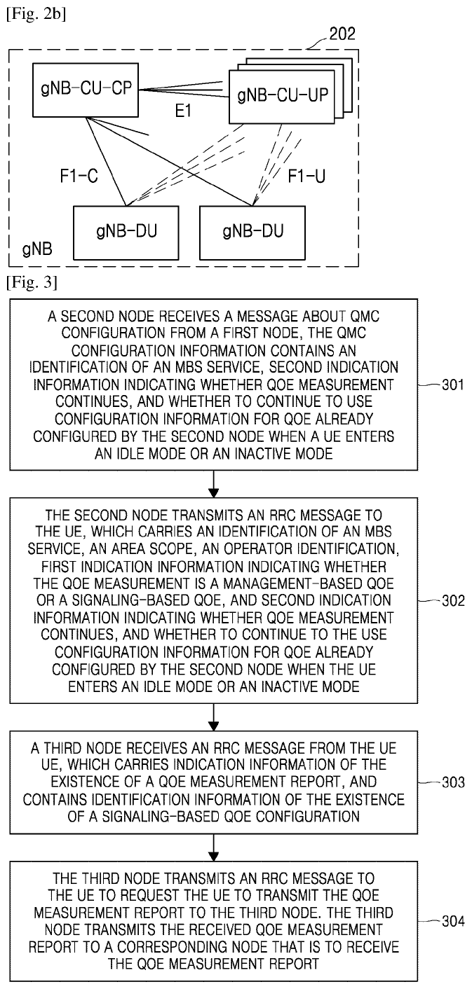

FIG. 2A and FIG. 2B are an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN, or RAN for short) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties. An interface between AMF and NG-RAN is called a NG-C interface, or a NG interface or a N2 interface. An interface between UPF and NG-RAN is called a NG-U interface, or a N3 interface, and the signaling between UE and AMF is called Non-Access Stratum Signaling (NAS), and also called a N1 interface. An interface between base stations is called an Xn interface. A base station of NG-RAN is called gNB, which can be a separate base station, where a gNB contains three entities, a gNB-CU-CP, a gNB-CU-UP and a gNB-DU. The gNB-CU-CP is a control plane entity of a gNB centralized node, the gNB-CU-UP is a user plane of a gNB centralized node, and the gNB-DU is a distributed node. Among them, the gNB-CU-UP and the gNB-CU-UP can be combined and called gNB base station node gNB-CU. An interface between gNB-CU-CP and gNB-CU-UP is called an E1 interface, and an interface between gNB-CU-CP and DU is called an F1 interface, which only has a control plane function. An interface between gNB-CU-UP and DU is also an F1 interface, which only has a user plane function.

In the third generation (3G) and fourth generation (4G) mobile communication systems, Quality of Experience (QoE) measurement collection for streaming media services and multimedia telephony services has been standardized by the 3rd Generation Partnership Project (3GPP). QoE Measurement Collection (QMC) can collect application layer measurement information of a UE, which can be measurement collection performed in a certain area or for a specific service or a certain service type of a specific UE (User Equipment). The collected information may be transmitted to a data center (such as a Measurement Collector Entity (MCE)), and further used to analyze and/or calculate Key Performance Indictor (KPI), so as to optimize the network and improve users'service experience, and ultimately enhance users'loyalty and increase revenue.

While in the fifth generation (5G) and B5G or 6G mobile communication systems, more and more new services need to be supported, for example new 5G services such as AR, MR, cloud games, etc., and also including MBS services supported in RRC_CONNECTED, RRC_INACTIVE and RRC_ IDLE states. Therefore, how to collect QoE to optimize the network when a UE is in an RRC_INACTIVE or RRC IDLE state is an important direction worthy of study.

The QoE measurement in the present disclosure may also be called QoE measurement collection (i.e. QMC), both refer to the QoE measurement configured by the 3GPP network and performed by UE, and finally these measurement results will be reported to the 3GPP network or the operator server. According to an initiation mode, it may be classified into a management-based QoE measurement and a signaling-based QMC. According to an implementation, a QMC may be initiated by a network element management node, and this type of QMC is called management-based QMC. In the management-based QMC, an access network entity receives a QMC configuration message from a network element management node. According to another implementation, a QMC may be initiated by a core network entity, and this type of QMC is called signaling-based QMC. In the signaling-based QMC, an access network entity receives a QMC configuration message from a core network entity. In some examples, the core network entity may be, for example, an Access and Mobility Management Function (AMF). However, it should be understood that this is only an example. A core network entity that transmits the QMC configuration message may also be another entity (such as a base station).

### Embodiment 1

### Schematic Diagram of a Method

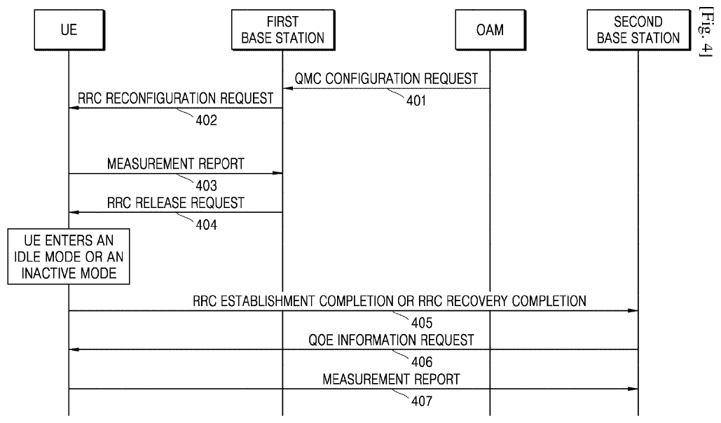

FIG. 3 is a schematic diagram showing a configuration and reporting flow for QoE measurement collection. Through this embodiment, the QoE measurement can be collected when the UE is in an RRC_INACTIVE or RRC_ IDLE state, to optimize the network.

As shown in FIG. 3, in Step 301, a first node transmits a message about QMC configuration to a second node. The first node may be an Operations, Administration and Maintenance (OAM) node, the first node may also be a core network node, which may include nodes such as UDM, AMF, SMF or UPF, and the first node may also be an access network node, such as a secondary base station or a master base station in dual-connectivity. The second node is an access network node, which may be an eNB of a 4G system or a gNB or eNB of a 5G system, or a master base station or a secondary base station in dual-connectivity. In an implementation, the first node allocates a measurement configuration application layer identification for a QoE measurement, which corresponds to a group of QoE measurement, and the specific QoE measurement collection information is stored in the context of the UE.

The message about QMC configuration carries configuration information for QMC, which may contain one or more of the following information:
a QE reference, which indicates a network request session, and is globally unique, containing an operator identification and an identification generated by a management system or the operator. The QoE reference is used to uniquely identify a QoE measurement on a service node or a measurement collection center node.
a service type, which indicates a service type of a QoE measurement, for example, it may indicate that the service type of a QoE measurement is a streaming service, a VR service, or a broadcast multicast service MBS, etc. If it is an MBS service, a service identification of the MBS, such as TMGI, may be further indicated.
an area scope, which may be identifications of a group of cells, identifications of a group of Tracking Areas, such as TACs, or identifications of a group of TAs, or identifications of a group of RAN Notification Areas (RNAs), in which the RNA corresponds to one or more cells.
operator identifications, a PLMN target list. The PLMN target list contains identifications of a group of operators, indicating identifications of operators which can perform the QoE measurement. For example, when the second node serves multiple operators, in an area-based QMC measurement, only when the PLMN of a serving PLMN of a UE is the same as a PLMN target, the second node may be able to select the UE or the session for the QMC measurement.
an IP address of a Measurement Collector Entity (MCE), which indicates the IP address of a node receiving the QoE measurement. Or a domain name of an MCE, indicating the domain name of the node receiving the QoE measurement.
a container for application layer measurement configuration, which contains a configuration file for QMC. The configuration file for QMC contains a specific configuration matrix for the QoE measurement in the application layer. The second node does not parse information in the container and forwards it to the UE, and the application layer of the UE parses it.
a state of the QoE measurement, which indicates whether a QoE measurement is started.
first indication information, that is, QoE measurement continuity indication information, which indicates whether QoE measurement is allowed to continue when the UE enters an idle mode or an inactive mode, and whether to continue to use configuration information for the QoE already configured by the second node when the UE enters an idle mode or an inactive mode.
a matrix of QoE visible to RAN. It defines a matrix of QoE visible to RAN that can be configured by the access network, which, for example, contains an application layer cache list, which defines an indicator about whether the RAN can use an application layer cache level list as the QoE visible to RAN. It may further contain media-initiated playback delay information, herein the playback delay information defines whether the playback delay may be served as the measurement collection of the QoE visible to RAN.
a measurement configuration application layer identification. The identification defines an application layer measurement, is allocated by the second node, is an integer value, corresponds to configuration information for a group of QoE. A certain measurement configuration application layer identification corresponds to a group of specific configuration information, such as corresponds to a QoE reference, a service type, an area scope, and an IP address of a Measurement Collector Entity (MCE).

Through this identification, the second node may find corresponding configuration information for a group of QoE from the context of the UE.
a node type or node identification of the first node, for example, the first node is a secondary base station, and the node type of the first node indicates that the node is a secondary base station, or contains an identification of a secondary base station.

The second node is an access network node, which may be an eNB of a 4G system, a gNB or eNB of a 5G system, or a base station in other systems. According to an implementation, the second node allocates a measurement configuration application layer identification for a QoE measurement, which corresponds to a group of QoE measurement, and the specific QoE measurement collection information is stored in the context of the UE. When the first node is an OAM node or an access network node, the second node needs to select a UE for QoE measurement.

If Step 301 contains the first indication information indicating that the QoE measurement is allowed to continue when the UE enters an idle mode or an inactive mode, the second node selects a UE supporting this capability, which means that in the previous steps, such as an RRC connection establishment process or a UE context establishment process, the second node has obtained capability information of whether the UE supports the continuation of QoE in an idle mode or an inactive mode.

This capability information may be transmitted to the second node by the UE or transmitted to the second node by the core network, and the second node stores this capability information in the context of the UE for reference when selecting the UE for QoE measurement.

When the selected UE does not have this capability, the configuration for QoE only supports the UE to measure and report in a connected mode, and the second node transmits the measurement configuration application layer identification and a container for an application layer measurement configuration to the UE.

If the selected UE has this capability, the base station needs to transmit more specific configuration information for QoE to the UE. Specifically, in Step 302, the second node transmits an RRC message to the UE, which carries configuration information about QoE to be transmitted to the UE, and the configuration information about QoE contains one or more of the following information:
a measurement configuration application layer identification. The identification defines an application layer measurement, is allocated by the second node, is an integer value, corresponds to configuration information for a group of QoE. A certain measurement configuration application layer identification corresponds to a group of specific configuration information, such as corresponds to a QoE reference, a service type, an area scope, and an IP address of a Measurement Collector Entity (MCE). Through this identification, the second node may find corresponding configuration information for a group of QoE from the context of the UE.
a container for application layer measurement configuration, which contains a configuration file for QMC.
an identification of an MBS service, such as TMGI.
an area scope, which may be identifications of a group of cells, identifications of a group of Tracking Areas, such as TACs, or identifications of a group of TAs, or identifications of a group of RAN Notification Areas (RNAs), in which the RNA corresponds to one or more cells.
a QoE reference, which indicates a network request session, and is globally unique, containing an operator identification and an identification generated by a management system or the operator. The QoE reference is used to uniquely identify a QoE measurement on a service node or a measurement collection center node.
first indication information, which indicates whether the QoE measurement is allowed to continue when the UE enters an idle mode or an inactive mode, and whether to continue to use configuration information for QoE already configured by the second node when the UE enters an idle mode or an inactive mode.
second indication information, which indicates whether the QoE measurement is a management-based QoE measurement or not, or indicates whether the QoE measurement is a management-based QoE or a signaling-based QoE.
a node type or node identification or node-related information, which indicates the type of the node receiving the QoE measurement report, or, a corresponding node may be found through the node identification or node-related information.

For example, for a QoE measurement visible to RAN, if the QoE measurement visible to RAN is configured by a secondary node, the secondary node needs to receive the QoE measurement visible to RAN in order for a secondary base station to perform reconfiguration for corresponding resources, then the message in Step 302 may further include a node type, and if the node type is set as a secondary base station, it means that the QoE measurement is to be collected by a secondary base station.

Step 302 may further include a node identification, then it means that the QoE measurement is to be collected by a node indicated by the identification. When the second node receives a QoE measurement report reported by the UE, which may carry a node type or node identification or node-related information, the second node forwards the measurement report to a node indicated by the node type or to a node indicated by the node identification and node-related information. The node-related information may be a mapping corresponding to the IP address of the node, and the mapping relationship may be pre-configured on the base station by the operation and maintenance, and the second node can find the corresponding node through the node-related information. For example, the measurement report is to be transmitted to an MCE, and the measurement report transmitted by the UE contains information related to the IP address of the MCE. The second node receives the measurement report, finds the IP address of the MCE according to the mapping information, and forwards the measurement report to the corresponding MCE.

The UE receives the message in Step 302 and performs measurement according to the configuration for QoE. When the UE enters an idle mode or an inactive mode, if allowed, the measurement for QoE is continued, and the measurement result of QoE is stored in the UE. When the UE re-enters an RRC connected mode, the UE transmits an RRC message to the serving base station. The process of Step 303 is performed.

Step 303: a third node receives a message from the UE, which may carry third indication information indicating the existence of a QoE measurement report, and fourth indication information indicating whether a signaling-based QoE configuration exists or not, or whether the existing QoE configuration is a management-based QoE or a signaling-based QoE.

According to the third indication information, the third node knows whether the QoE measurement report exists, and the third node may decide whether to transmit an RRC message to the UE. Through Step 304, the UE is requested to transmit the QoE measurement report to the third node, and the third node transmits the received QoE measurement report to a corresponding node to receive the QoE measurement report. As mentioned above, if the QoE measurement report contains the node type or node identification or node-related information, the third node may transmit the measurement report to a corresponding node based thereon.

According to the fourth indication information, the third node knows that the UE has been configured with a signaling-based QoE configuration, so the third node does not select the UE to perform another management-based QoE measurement, so as to avoid covering the configured signaling-based QoE measurement with the management-based QoE measurement.

### Embodiment 2

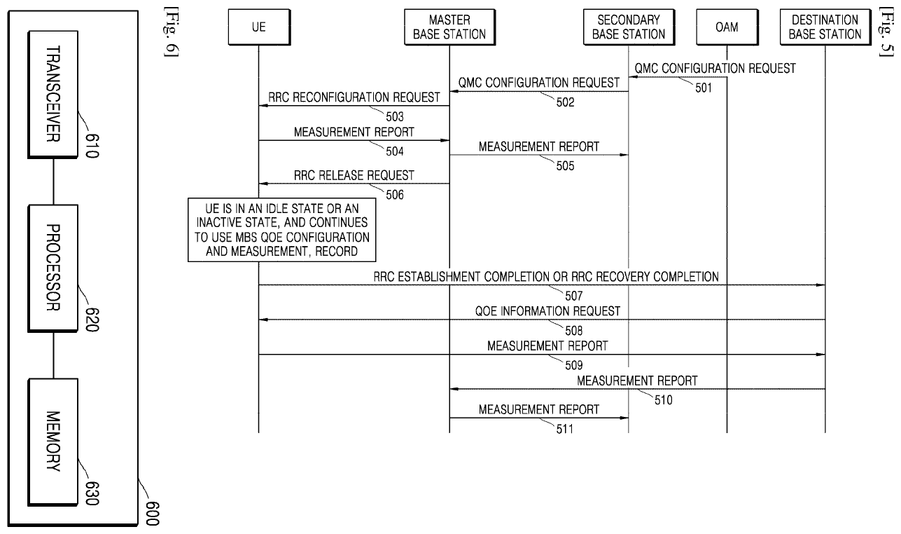

Embodiment 2 of FIG. 4 describes a configuration process of QoE and a reporting process of a QoE measurement result. Steps irrelevant to the present disclosure are omitted, and through this embodiment, the continuity of QoE measurement can be ensured, and the base station is prevented from configuring another QoE measurement to cover an already configured QoE measurement. The process shown in FIG. 4 is also applicable to a configuration process of a signaling-based QoE and a reporting process of a QoE measurement result, and only needs to be modified adaptively. The specific process is shown in FIG. 4.

Step 401: For a configuration process of a management-based QoE, an OAM node or OAM functionality transmits a QoE configuration request message to a first base station, which is a secondary base station. For a configuration process of a signaling-based QoE, the core network node transmits a UE context establishment request, a UE context modification request, or a handover request message, which carries configuration information for QoE (also called configuration information for QMC, the same below). The configuration information for QoE may include one or more of the following information:
a QoE reference, which indicates a network request session, and is globally unique, containing an operator identification and an identification generated by a management system or the operator. The QoE reference is used to uniquely identify a QoE measurement on a service node or a measurement collection center node. The QoE reference also corresponds to the following group of information related to QoE configuration, such as a service type, an area scope, etc.
a service type, which indicates a service type of a QoE measurement, for example, it may indicate that the service type of a QoE measurement is a streaming service, a VR service, or a broadcast multicast service MBS, etc. If it is an MBS service, a service identification of the MBS, such as TMGI, may be further indicated.
an area scope, which may be identifications of a group of cells, identifications of a group of Tracking Areas, such as TACs, or identifications of a group of TAs, or identifications of a group of RAN Notification Areas (RNAs), in which the RNA corresponds to one or more cells.
operator identifications, a PLMN target list. The PLMN target list contains identifications of a group of operators, indicating identifications of operators which can perform the QoE measurement. For example, when a first base station serves multiple operators, the configuration information also contains a PLMN target list. In an area-based QMC measurement, only when the PLMN of a serving PLMN of a UE is the same as a PLMN target, the UE or the session is able to be selected for QMC measurement.
an IP address of a Measurement Collector Entity (MCE), which indicates the IP address of a node receiving the QoE measurement. Or a domain name of an MCE, indicating the domain name of the node receiving the QoE measurement.
a container for application layer measurement configuration, which contains a configuration file for QMC. The configuration file for QMC contains a specific configuration matrix for QoE measurement in the application layer. The second node does not parse information in the container and forwards it to the UE, and the application layer of the UE parses it.
a state of QoE measurement, which indicates whether a QE measurement is started.
QoE measurement continuity indication information, indicating whether the configuration for QoE is a general configuration, which is applicable for an RRC connected mode, an RRC inactive mode or an RRC idle mode. The indication information indicates whether the measurement for QoE will continue or whether to continue to use the configuration information for QoE corresponding to the QoE reference when the UE enters an idle mode or an inactive mode, that is, the configuration information for QoE used when the UE enters an idle mode or an inactive mode is the same as that used in a connected mode.
a matrix of QoE visible to RAN. It defines a matrix of QoE visible to RAN that can be configured by the access network, which, for example, contains an application layer cache list, which defines an indicator about whether the RAN can use an application layer cache level list as the QoE visible to RAN. It may further contain media-initiated playback delay information, wherein the playback delay information defines whether the playback delay may be served as the measurement collection of the QoE visible to RAN.

After receiving the configuration information for QoE, the first base station stores the information in the context of the UE if it is configuration information for a signaling-based QoE.

After receiving the configuration information for QoE, for configuration information for management-based QoE, if the configuration information for QoE contains an identification of an MBS service, the first base station selects a UE that has joined the MBS service and is within an area scope. Being within an area scope means that the serving operator identification of the UE is the same as the operator identification in the configuration information for QoE, and the cell where the UE is located is contained in a cell list of the area scope, or the TA where the UE is located is contained in a TA list of the area scope. After the UE is selected, the first base station stores the configuration information for QoE in the context of the selected UE.

According to the selected UE's capability and/or the received indication information on whether the QoE measurement is continuous, the first base station judges whether the QoE measurement will continue and whether to continue the QoE measurement in the connected mode when the selected UE enters an idle mode or an inactive mode, that is, the configuration information for QoE used when the UE enters an idle mode or an inactive mode is the same as that used in a connected mode.

The first base station allocates a measurement configuration application layer identification for the QoE measurement to the UE, and transmits the identification to the UE, which can reduce the specific measurement configuration information transmitted to the UE. If the UE only performs the measurement and reporting for the QoE in an RRC connected mode, the first base station only needs to transmit the identification to the UE, and other information is stored in the UE context of the base station.

When the first base station judges that the QoE measurement needs to continue when the UE enters an idle mode or an inactive mode according to the received QoE measurement continuity indication information and/or the UE's capability, the first base station needs to transmit more configuration information to the UE, such as the identification of an MBS service, an area scope, a QoE reference, MCE indication information, QoE measurement continuity indication information, and indication information of whether the QoE measurement is based on management or signaling.

Step 402: the first base station transmits an RRC reconfiguration request message to the UE to inform the UE about the configuration for QoE. The configuration information about QoE contains one or more of the following information:
a measurement configuration application layer identification. The identification defines an application layer measurement, is allocated by the first base station, is an integer value, and corresponds to configuration information for a group of QoE. A certain measurement configuration application layer identification corresponds to a group of specific configuration information, such as corresponds to a QoE reference, a service type, an area scope, and an IP address of a Measurement Collector Entity (MCE). Through this identification, the first base station may find corresponding configuration information for a group of QoE from the context of the UE.
a container for application layer measurement configuration, which contains a configuration file for QMC.
an identification of an MBS service, such as TMGI.
an area scope, which may be identifications of a group of cells, identifications of a group of Tracking Areas, such as TACs, or identifications of a group of TAs, or identifications of a group of RAN Notification Areas (RNAs), in which the RNA corresponds to one or more cells.
a QoE reference, which indicates a network request session, and is globally unique, containing an operator identification and an identification generated by a management system or the operator. The QoE reference is used to uniquely identify a QoE measurement on a service node or a measurement collection center node.
QoE measurement continuity indication information, which indicates whether the measurement for QoE will continue and whether to continue to use the configuration information for QoE corresponding to the QoE reference when the UE enters an idle mode or an inactive mode, that is, the configuration information for QoE used when the UE enters an idle mode or an inactive mode is the same as that used in a connected mode.
indication information of whether the QoE measurement is a management-based QoE or a signaling-based QoE, which indicates whether the QoE measurement is a management-based QoE measurement or not, or whether the QoE measurement is a management-based QoE QoE or a signaling-based QoE.
information related to an MCE. The information related to an MCE may be a mapping corresponding to the IP address of the node, and the base station may find the corresponding MCE through the information related to an MCE. For example, the message of QoE measurement result transmitted by UE contains the information related to an MCE, and the base station finds the IP address corresponding to the MCE through the information related to an MCE and forwards the measurement report to the corresponding MCE. The mapping relationship may be pre-configured on the base station by the operation and maintenance.

The UE receives the above information and stores the above information. According to the configuration information in the container, the UE performs QoE measurement for the services of the application layer, and the measurement result of the application layer is transmitted to the access layer of the UE, and the access layer of the UE receives the measurement result of the application layer, and transmits an RRC message to report the QoE measurement result of the application layer to the first base station.

Step 403: the UE transmits an RRC message measurement report application layer to the first base station. The message contains the measurement configuration application layer identification and a container. The container contains the measurement results of the application layer.

The first base station finds the specific configuration information for QoE corresponding to the measurement configuration application layer identification according to the stored configuration information for QoE, and the first base station may transmit the measurement result of the application layer to the measurement center entity MCE.

Step 404: the first base station transmits an RRC release request to let the UE enter an RRC idle mode or an inactive mode. The QoE measurement continuity indication information may be further contained in this step, which indicates whether the measurement for QoE will continue and whether to continue to use the configuration information for QoE corresponding to the QoE reference when the UE enters an idle mode or an inactive mode, that is, the configuration information for QoE used when the UE enters an idle mode or an inactive mode is the same as that used in a connected mode.

The UE enters an idle mode or enters an inactive mode.

The UE continues to perform the QoE measurement, and stores measurement results at the UE end. When the UE moves, it judges whether a target cell still belongs to the measurement scope according to the measurement scope of QoE and the operator identification. If so, the measurement continues, and if not, the QoE measurement is not performed in this cell. If it is a QoE measurement for a certain MBS broadcast service, the UE can receive broadcast information of the cell, and know whether the cell is performing transmission of the MBS data, if so, the measurement is performed, and if the cell is not performing transmission of the MBS data, the measurement may be stopped.

The UE moves to a cell under the second base station. If the UE needs to enter the RRC connected mode, the UE initiates an RRC establishment request or an RRC recovery request message to the base station, the base station allows the UE to access, and the base station will transmit an RRC establishment message or an RRC recovery message to the UE, and then the UE transmits the message in step 405. In step 405, in the RRC establishment completion message, RRC recovery completion message, or other RRC messages, the UE may carry indication information of the existence of a QoE measurement report and/or carry indication information of QoE configuration. The indication information of the existence of a QoE measurement report indicates that the UE has stored the measurement result of QoE, which has not been reported to the base station. The indication information of QoE configuration indicates whether the QoE measurement stored at the UE end is a management-based QoE or a signaling-based QoE. If the UE can store configurations for multiple QoEs, the message in step 405 may further include a QoE reference, or may further include a measurement configuration application layer identification.

Step 406: the second base station transmits a QoE information request message to the UE, so that the UE can upload the measurement result of QoE to the second base station. The message may carry the QoE reference, the measurement configuration application layer identification, and the message can carry the MBS identification TMGI.

Step 407: the UE transmits an RRC message and transmits the measurement result of QoE to the second base station. The message contains the measurement configuration application layer identification, and may further contain a QoE reference, information related to an MCE and a container of application layer. Through the information related to an MCE, the second base station may find the IP address corresponding to the MCE. The second base station may transmit the measurement result of QoE to the corresponding IP address. The container contains the measurement results of the application layer.

### Embodiment 3

Embodiment 3 of FIG. 5 describes a configuration process for a secondary base station to initiate a management-based QoE and a process for a secondary base station to receive a QoE measurement result when the UE is in dual-connectivity. Steps irrelevant to the present disclosure are omitted. Through this embodiment, the configuration conflict between the secondary base station and the master base station can be avoided, and the QoE measurement report can be transmitted to the corresponding base station, thus reducing the waste of network resources. The process shown in FIG. 5 is also applicable to a configuration process of QoE visible to RAN and a reporting process of QoE measurement results visible to RAN, and only needs to be modified adaptively. The specific process is shown in FIG. 5.

Step 501: for a configuration process of a management-based QoE, the OAM node or OAM functionality transmits a QMC configuration request message to the secondary base station. The QMC configuration information may contain one or more of the following information:
a QoE reference, which indicates a network request session, and is globally unique, containing an operator identification and an identification generated by a management system or the operator. The QoE reference is used to uniquely identify a QoE measurement on a service node or a measurement collection center node. The QoE reference also corresponds to the following group of information related to QoE configuration, such as a service type, an area scope, etc.
a service type, which indicates a service type of a QoE measurement, for example, it may indicate that the service type of a QoE measurement is a streaming service, a VR service, or a broadcast multicast service MBS, etc. If it is an MBS service, a service identification of the MBS, such as TMGI, may be further indicated.
an area scope, which may be identifications of a group of cells, identifications of a group of Tracking Areas, such as TACs, or identifications of a group of TAs, or identifications of a group of RAN Notification Areas (RNAs), in which the RNA corresponds to one or more cells.
operator identifications, a PLMN target list. The PLMN target list contains identifications of a group of operators, indicating identifications of operators which can perform the QoE measurement. For example, when the secondary base station serves multiple operators, the configuration information also contains a PLMN target list. In an area-based QMC measurement, only when the PLMN of a serving PLMN of a UE is the same as a PLMN target, the UE or the session is able to be selected for QMC measurement.
an IP address of a Measurement Collector Entity (MCE), which indicates the IP address of a node receiving the QoE measurement.
a container for application layer measurement configuration, which contains a configuration file for the QMC.
QoE measurement continuity indication information, which indicates whether the measurement for QoE will continue and whether to continue to use the configuration information for QoE corresponding to the QoE reference when the UE enters an idle mode or an inactive mode, that is, the configuration information for QoE used when the UE enters an idle mode or an inactive mode is the same as that used in a connected mode.
a matrix of QoE visible to RAN. It defines a matrix of QoE visible to RAN that can be configured by the access network, which, for example, contains an application layer cache list, which defines an indicator about whether the RAN can use an application layer cache level list as the QoE visible to RAN. It may further contain media-initiated playback delay information, wherein the playback delay information defines whether the playback delay may be served as the measurement collection of the QoE visible to RAN.

Step 502: the secondary base station receives the QMC configuration information. If it is configuration information for a management-based QoE, an implementation is that the secondary base station selects a UE that is performing the service type and is within an area scope. Being within an area scope means that the serving operator identification of the UE is the same as the operator identification in the configuration information for QoE, and the cell where the UE is located is contained in a cell list of the area scope, or the TA where the UE is located is contained in a TA list of the area scope. After the UE is selected, the secondary base station stores the configuration information for QoE in the context of the UE. If the UE is in dual-connectivity, the secondary base station transmits a message of QMC configuration request to the master base station.

An implementation is that the secondary base station has allocated a measurement configuration application layer identification, and the secondary base station generates an RRC message (or an information element of RRC, both described as an RRC message below) of an application layer measurement configuration to be transmitted to the UE. The RRC message of the application layer measurement configuration is transmitted to the master base station through an RRC container, and then the master base station transmits it to the UE. The RRC message generated by the secondary base station may contain the measurement configuration application layer identification, the identification of the secondary base station, and the measurement configuration application layer container. Specifically, the secondary base station transmits a QMC configuration request message to the master base station, which may contain one or more of the following information:
a QoE reference.
a measurement configuration application layer identification.
an RRC container. The RRC container contains an RRC message of application layer measurement configuration generated by the secondary base station and to be transmitted to the UE. If it is QoE measurement visible to RAN, the RRC message of the application layer measurement configuration further contains parameters of QoE visible to RAN. For example, it includes a cycle, cache related information and delay related information. The RRC container may further contain a container for application layer measurement configuration, which contains a configuration file for QMC.
indication information for QoE measurement visible to RAN, which indicates that the QoE measurement corresponding to the QoE reference is a QoE measurement visible to RAN. For a QoE measurement visible to RAN initiated by the secondary base station, the master base station needs to configure the UE with information related to the secondary base station, such as the base station type, or the base station identification, or the information related to the base station identification. When the UE transmits the measurement report of QoE to the master base station, the message carries information related to the secondary base station. If the master base station receives an RRC message containing the measurement result of QoE transmitted by the UE, wherein the RRC message contains the measurement configuration application layer identification and the type of a base station (such as a secondary base station) or a base station identification or information related to a base station identification, and thus, the master base station can know that the measurement report of QoE visible to RAN needs to be forwarded to the secondary base station, and even if the measurement configuration application layer identification conflicts, the master base station knows which base station the report needs to be transmitted to through the base station type, the base station identification or the information related to the base station identification.
indication information about whether the master base station needs to transmit measurement results to the secondary base station, according to the indication information, the master base station needs to configure the UE with information related to the secondary base station, such as the base station type, or the base station identification, or the information related to the base station identification.
an IP address or related information of a Measurement Collector Entity (MCE), which indicates the IP address of the node receiving the QoE measurement or information of a mapping with the IP address. For a measurement result of QoE that is not visible to RAN, if the master base station receives the measurement result of QoE transmitted by the UE, the master base station may transmit the measurement result to the MCE.
configuration information of QoE-related control channels, which may be carried in an RRC container. If the UE is allowed to directly transmit the measurement report to the secondary base station, the message may further carry a configuration of an uplink control channel configured by the secondary base station to transmit the QoE measurement report, and the UE transmits the QoE measurement report to the secondary base station through the uplink control channel.

An implementation is that the secondary base station transmits all the configuration information for QMC to the master base station, and the master base station allocates the measurement configuration application layer identification, in order to avoid the conflict between the measurement configuration application layer identification allocated by the master base station and the measurement configuration application layer identification allocated by the secondary base station. Specifically, the secondary base station transmits a message of QMC configuration request to the master base station, and the message of QMC configuration request contains one or more of the following information:
a QoE reference, which indicates a network request session, and is globally unique, containing an operator identification and an identification generated by a management system or the operator. The QoE reference is used to uniquely identify a QoE measurement on a service node or a measurement collection center node. The QoE reference also corresponds to the following group of information related to QoE configuration, such as a service type, an area scope, etc.
a service type, which indicates a service type of a QoE measurement, for example, it may indicate that the service type of a QoE measurement is a streaming service, a VR service, or a broadcast multicast service MBS, etc. If it is an MBS service, a service identification of the MBS, such as TMGI, may be further indicated.
an area scope, which may be identifications of a group of cells, identifications of a group of Tracking Areas, such as TACs, or identifications of a group of TAs, or identifications of a group of RAN Notification Areas (RNAs), in which the RNA corresponds to one or more cells.
operator identifications, a PLMN target list. The PLMN target list contains identifications of a group of operators, indicating identifications of operators which can perform the QoE measurement. For example, when the master base station or secondary base station serves multiple operators, the configuration information also contains a PLMN target list. In an area-based QMC measurement, only when the PLMN of a serving PLMN of a UE is the same as a PLMN target, the UE or the session is able to be selected for QMC measurement.
an IP address of a Measurement Collector Entity (MCE), which indicates the IP address of a node receiving the QoE measurement. Or a domain name of an MCE, indicating the domain name of the node receiving the QoE measurement.
a container for application layer measurement configuration, which contains a configuration file for QMC. The configuration file for QMC contains a specific configuration matrix for QoE measurement of the application layer. The master base station does not parse information in the container and forwards it to the UE, and the application layer of the UE parses it.
QoE measurement continuity indication information, which indicates whether the measurement for QoE will continue and whether to continue to use the configuration information for QoE corresponding to the QoE reference when the UE enters an idle mode or an inactive mode, that is, the configuration information for QoE used when the UE enters an idle mode or an inactive mode is the same as that used in a connected mode.
indication information for QoE measurement visible to RAN, which indicates that the QoE measurement corresponding to the QoE reference is a QoE measurement visible to RAN.
a matrix of QoE visible to RAN. It defines a matrix of QoE visible to RAN that can be configured by the access network, which, for example, contains an application layer cache list, which defines an indicator about whether the RAN can use an application layer cache level list as the QoE visible to RAN. It may further contain media-initiated playback delay information, wherein the playback delay information defines whether the playback delay may be served as the measurement collection of the QoE visible to RAN.

The master base station allocates the measurement configuration application layer identification for the QoE measurement to the UE, and transmits the identification to the UE, which can reduce the specific measurement configuration information transmitted to the UE. If the UE only performs the measurement and reporting of the QoE in an RRC connected mode, the master base station only needs to transmit the identification to the UE, and other information is stored in the UE context of the master base station.

If the master base station knows that the QoE measurement needs to continue when the UE enters an idle mode or an inactive mode according to the received QoE measurement continuity indication information, the master base station needs to transmit more configuration information to the UE, such as the identification of an MBS service, an area scope, a QoE reference, MCE indication information, QoE measurement continuity indication information, and indication information of whether the QoE measurement is based on management or signaling.

Step 503: the master base station transmits an RRC reconfiguration request message to the UE to inform the UE about the configuration for QoE. The configuration information about QoE contains one or more of the following information:
a measurement configuration application layer identification. The identification defines an application layer measurement, is an integer value, and corresponds to configuration information for a group of QoE. A certain measurement configuration application layer identification corresponds to a group of specific configuration information, such as corresponds to a QoE reference, a service type, an area scope, and an IP address of a Measurement Collector Entity (MCE). Through this identification, the base station may find corresponding configuration information for a group of QoE from the context of the UE.
a container for application layer measurement configuration, which contains a configuration file for QMC.
an identification of an MBS service, such as TMGI.
an area scope, which may be identifications of a group of cells, identifications of a group of Tracking Areas, such as TACs, or identifications of a group of TAs, or identifications of a group of RAN Notification Areas (RNAs), in which the RNA corresponds to one or more cells.
a QoE reference, which indicates a network request session, and is globally unique, containing an operator identification and an identification generated by a management system or the operator. The QoE reference is used to uniquely identify a QoE measurement on a service node or a measurement collection center node.
QoE measurement continuity indication information, which indicates whether the measurement for QoE will continue and whether to continue to use the configuration information for QoE corresponding to the QoE reference when the UE enters an idle mode or an inactive mode, that is, the configuration information for QoE used when the UE enters an idle mode or an inactive mode is the same as that used in a connected mode.
indication information of whether the QoE measurement is a management-based QoE or a signaling-based QoE.
information related to an MCE. Through the information related to an MCE, the IP address corresponding to an MCE can be found.
a matrix of QoE visible to RAN.
indication information for QoE measurement visible to RAN, which indicates that the QoE measurement corresponding to the QoE reference is a QoE measurement visible to RAN.

The UE receives the above information and stores the above information. According to the configuration information in the container, the UE performs the QoE measurement on the services of the application layer, and the measurement result of the application layer is transmitted to the access layer of the UE, and the access layer of the UE receives the measurement result of the application layer, and transmits an RRC message to report the QoE measurement result of the application layer to the master base station.

Step 504: the UE transmits an RRC message measurement report application layer to the master base station. The message contains the measurement configuration application layer identification and a container. The container contains the measurement results of QoE of the application layer.

According to the stored configuration information for QoE, the master base station finds the specific configuration information for QoE corresponding to the measurement configuration application layer identification, and the master base station may transmit the measurement result of the application layer to the measurement center entity MCE.

The message of Step 504 may further contain one or more of the following information:
indication information for QoE measurement visible to RAN, which indicates that the QoE measurement corresponding to the QoE reference is a QoE measurement visible to RAN.
a type of a base station, or identification of a base station, or related information of a base station. For example, the information indicates that the type of the base station initiating the QoE visible to RAN is a secondary base station or a master base station. The master base station can transmit the measurement of the QoE to a corresponding base station through the type of the base station, or the identification of the base station, or the related information of the base station.

Step 505: if it is a measurement result of QoE visible to RAN, the master base station forwards the measurement result of QoE to the secondary base station through the base station type or the base station identification contained in the measurement report, or through the QoE information contained in the context of the UE.

Step 506: the master base station transmits an RRC release request to let the UE enter an RRC idle mode or an inactive mode. This step may further include QoE measurement continuity indication information, which indicates whether the measurement for QoE will continue and whether to continue to use the configuration information for QoE corresponding to the QoE reference when the UE enters an idle mode or an inactive mode, that is, the configuration information for QoE used when the UE enters an idle mode or an inactive mode is the same as that used in a connected mode

The UE enters an idle mode or enters an inactive mode.

The UE continues to perform QoE measurement, and stores measurement results at the UE end. When the UE moves, it judges whether a target cell still belongs to the measurement scope according to the measurement scope of QoE and the operator identification. If so, the measurement continues, and if not, the QoE measurement is not performed in this cell. For a QoE measurement for a certain MBS broadcast service, the UE can receive broadcast information of the cell, and know whether the cell is performing transmission of the MBS data, if so, the measurement is performed, and if the cell is not performing transmission of the MBS data, the measurement may be stopped.

The UE moves to a cell under a destination base station, the UE needs to enter the RRC connected mode, and the UE initiates a process of RRC connection establishment or RRC connection recovery. In the completion message of RRC connection establishment or RRC connection restoration in Step 507, or other RRC messages, the UE may carry indication information of the existence of the QoE measurement report and/or indication information of the QoE configuration. The indication information of the existence of the QoE measurement report indicates that the UE has stored the measurement result of QoE, which has not been reported to the base station. The indication information of the QoE configuration indicates whether the measurement for QoE stored by the UE end is a management-based QoE or a signaling-based QoE. If the UE end can store the configurations of multiple QoEs, the message in Step 507 may further contain a QoE reference and may further contain a measurement configuration application layer identification.

Step 508: the destination base station transmits a QoE information request message to the UE, so that the UE can upload the measurement result of QoE to the destination base station. The message may carry the QoE reference, the measurement configuration application layer identification, and the message can carry the MBS identification TMGI.

Step 509: the UE transmits an RRC message and transmits the measurement result of QoE to the destination base station. The message contains the measurement configuration application layer identification, and may further contain a QoE reference, information related to an MCE and a container of the application layer. Through the information related to an MCE, the destination base station may find the IP address corresponding to the MCE. The container contains the measurement results of the application layer.

The message of Step 509 may further contain one or more of the following information:
indication information for QoE measurement visible to RAN, which indicates that the QoE measurement corresponding to the QoE reference is a QoE measurement visible to RAN.
a type of a base station, or an identification of a base station, or related information of a base station. For example, the information indicates that the type of the base station initiating the QoE visible to RAN is a secondary base station or a master base station. The master base station can transmit the measurement of the QoE to a corresponding base station through the type of the base station, or the identification of the base station, or the related information of the base station.
an identification or identification-related information of an old serving cell or serving base station, or an identification of the UE in the old serving cell, through the identification or identification-related information, a new base station and a destination base station can find the old serving base station. In this embodiment, the old serving base station is the master base station in FIG. 5.

Step 510: the destination base station transmits the measurement report to the master base station. According to the received information, such as the identification of the UE's old serving base station, or according to the information in the UE's context, the destination base station finds the old serving base station, and the destination base station transmits the received measurement report of QoE to the master base station. For example, for the QoE measurement visible to RAN, the old base station needs to get the QoE measurement report in order to set the management parameters.

Step 511: the master base station transmits the measurement report to the secondary base station.

According to the received measurement report of QoE, if the measurement report contains the identification of the secondary base station, the master base station may transmit the measurement report to the secondary base station.

In this embodiment, the measurement configuration application layer identification may be allocated by the master base station or the secondary base station, and the measurement configuration application layer identification is transmitted to the UE through an RRC message. If it is allocated by a secondary base station, in order to avoid the conflict between the measurement configuration application layer identification allocated by the secondary base station and the identification allocated by the master base station, the master base station may also carry a list of measurement configuration application layer identifications that can be used by the secondary base station in a message of a secondary base station addition request or a message of a secondary base station modification request, and the secondary base station may select one or more from the list of available measurement configuration application layer identifications to allocate corresponding measurement configuration application layer identifications for a certain QoE measurement. The secondary base station can also carry a list of used measurement configuration application layer identifications or the number of measurement configuration application layer identifications that are required to be allocated by the master base station, in a message for transmitting a secondary-base-station-needs-to-modify message to the master base station, or in a message for transmitting a secondary-base-station-addition-response message or a secondary-base-station-modification-response to the master base station. According to the required number, the master base station carries a list of available measurement configuration application layer identifications by the secondary base station in the secondary base station modification request message that the master base station transmits to the secondary base station, and the secondary base station adopts a new list to allocate the corresponding measurement configuration application layer identification for a certain QoE measurement.

So far, the method and device for Quality of Experience (QoE) measurement collection in the present disclosure have been completed. The conflict of QoE configuration can be avoided, and the continuity of QoE measurement report can be ensured, and the QoE measurement report can be transmitted to the corresponding base station, thus reducing the waste of network resources.

FIG. 6 is a block diagram of a node device 600 in a network according to the present disclosure.

Node devices in the network can be used to realize the DU, CU-UP, CU-CP, gNB, eNB source base station, destination station, source DU, source CU-UP, destination DU, destination CU-UP, destination CU-CP, master base station, secondary base station, OAM, UDM, AMF, SMF or UPF, etc. of the present disclosure.

Referring to the FIG. 6, the node device 600 may include a processor 620, a transceiver 610 and a memory 630. However, all of the illustrated components are not essential. The node device 600 may be implemented by more or less components than those illustrated in FIG. 6. In addition, the processor 620 and the transceiver 610 and the memory 630 may be implemented as a single chip according to another embodiment.

The aforementioned components will now be described in detail.

The processor 620 may include one or more processors or other processing devices that control the proposed function, process, and/or method. Operation of the node device 600 aforementioned in this disclosure may be implemented by the processor 620.

The transceiver 610 may include a RF transmitter for up-converting and amplifying a transmitted signal, and a RF receiver for down-converting a frequency of a received signal. However, according to another embodiment, the transceiver 610 may be implemented by more or less components than those illustrated in components.

The transceiver 610 may be connected to the processor 620 and transmit and/or receive a signal. The signal may include control information and data. In addition, the transceiver 610 may receive the signal through a wireless channel and output the signal to the processor 620. The transceiver 610 may transmit a signal output from the processor 620 through the wireless channel.

The memory 630 may store the control information or the data included in a signal obtained by the node device 600. The memory 630 may be connected to the processor 620 and store at least one instruction or a protocol or a parameter for the proposed function, process, and/or method. The memory 630 may include read-only memory (ROM) and/or random access memory (RAM) and/or hard disk and/or CD-ROM /d/ or DVD and/or other storage devices.

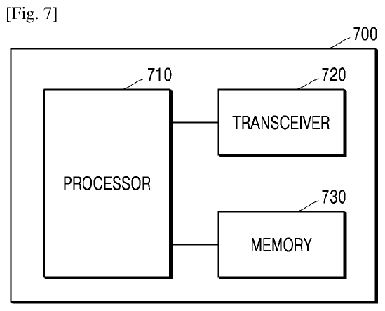

FIG. 7 is a block diagram of a UE 700 according to an embodiment of the present disclosure

Referring to the FIG. 7, the UE 700 may include a processor 710, a transceiver 720 and a memory 730. However, all of the illustrated components are not essential. The UE 700 may be implemented by more or less components than those illustrated in FIG. 7. In addition, the processor 710 and the transceiver 720 and the memory 730 may be implemented as a single chip according to another embodiment.

The aforementioned components will now be described in detail.

The processor 710 may include one or more processors or other processing devices that control the proposed function, process, and/or method. Operation of the UE 700 aforementioned in this disclosure may be implemented by the processor 710.

The transceiver 720 may include a RF transmitter for up-converting and amplifying a transmitted signal, and a RF receiver for down-converting a frequency of a received signal. However, according to another embodiment, the transceiver 720 may be implemented by more or less components than those illustrated in components.

The transceiver 720 may be connected to the processor 710 and transmit and/or receive a signal. The signal may include control information and data. In addition, the transceiver 720 may receive the signal through a wireless channel and output the signal to the processor 710. The transceiver 720 may transmit a signal output from the processor 710 through the wireless channel.

The memory 730 may store the control information or the data included in a signal obtained by the UE 200. The memory 730 may be connected to the processor 710 and store at least one instruction or a protocol or a parameter for the proposed function, process, and/or method. The memory 730 may include read-only memory (ROM) and/or random access memory (RAM) and/or hard disk and/or CD-ROM and/or DVD and/or other storage devices.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

A particular network entity may be implemented as a network element on a dedicated hardware, as a software instance running on a dedicated hardware, and/or as a virtualised function instantiated on an appropriate platform, e.g. on a cloud infrastructure.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

Embodiments of the disclosure can also be embodied as a storage medium including instructions executable by a computer such as a program module executed by the computer. A computer readable medium can be any available medium which can be accessed by the computer and includes all volatile/non-volatile and removable/non-removable media.

Further, the computer readable medium may include all computer storage and communication media. The computer storage medium includes all volatile/non-volatile and removable/non-removable media embodied by a certain method or technology for storing information such as computer readable instruction code, a data structure, a program module or other data. Communication media may typically include computer readable instructions, data structures, or other data in a modulated data signal, such as program modules. In addition, computer-readable storage media may be provided in the form of non-transitory storage media.

The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

According to an embodiment of the disclosure, a method according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

1-10. (canceled)

11. A method performed by a user equipment (UE) in a wireless communication system, comprising:
receiving, from a first base station, via a radio resource control (RRC) signaling, a quality of experience (QoE) measurement configuration information including information indicating QoE measurement configurations applicable in an RRC_IDLE state or in an RRC_INACTIVE state;
based on the QoE measurement configuration information, continuing ongoing QoE measurement collection when entering the RRC_IDLE or in the RRC_INACTIVE state; and
storing QoE measurement report generated while in the RRC_IDLE or in the RRC_INACTIVE state in the UE.

12. The method of claim 11, wherein the QoE measurement configuration information further includes at least one of:
a measurement configuration application layer identification,
a service type,
a QoE reference,
information indicating whether the QoE measurement is signaling based or management based,
an area scope, or
information related to a measurement collector entity (MCE).

13. The method of claim 11, further comprising:
when the UE moves to an RRC_CONNECTED state, transmitting, to a second base station, an indication information of QoE measurement report availability;
receiving, from the second base station, a request for retrieving the QoE measurement report; and
transmitting, to the second base station, the QoE measurement report buffered when in the RRC_IDLE or in the RRC_INACTIVE state.

14. The method of claim 13, wherein the QoE measurement report includes at least one of:
a measurement configuration application layer identification,
a QoE reference, or
information related to an MCE.

15. The method of claim 12, wherein:
the service type is one of: a streaming service or a VR service, and
application data for the streaming service or for the VR service is delivered via MBS broadcast service.

16. The method of claim 11, wherein: in case of the UE in a dual connectivity,
a measurement configuration application layer identification for the QoE measurement configuration is allocated by a master node (MN), and
the measurement configuration application layer identification is indicated to the UE by the MN.

17. The method of claim 16, wherein: in case of the UE in the dual connectivity,
a management-based QoE measurement configuration is received by-a secondary node (SN) from an operations, administration and maintenance (OAM) node, and
the UE is selected by the SN based on the management-based QoE measurement configuration.

18. The method of claim 17, wherein: in case of the UE in the dual connectivity, the method further comprising:
receiving, from the SN, the QoE measurement configuration, wherein:
the UE is configured to transmit the QoE measurement report to the MN,
a QoE reference and a MCE IP address are indicated by the SN to the MN, and
the QoE measurement report is determined to be forwarded from the MN directly to a MCE by the SN; and
transmitting the QoE measurement report to the MN.

19. A method performed by a base station (BS) in a wireless communication system, comprising:
transmitting, to a user equipment (UE), via a radio resource control (RRC) signaling, a quality of experience (QoE) measurement configuration information including information indicating QoE measurement configurations applicable in an RRC_IDLE state or in an RRC_INACTIVE state,
wherein:
based on the QoE measurement configuration information, the UE continues ongoing QoE measurement collection when entering the RRC_IDLE or in the RRC_INACTIVE state, and
the UE stores QoE measurement report generated while in the RRC_IDLE or in the RRC_INACTIVE state in the UE.

20. The method of claim 19, wherein the QoE measurement configuration information further includes at least one of:
a measurement configuration application layer identification,
a service type,
a QoE reference,
information indicating whether the QoE measurement is signaling based or management based,
an area scope, or
information related to a measurement collector entity (MCE).

21. A user equipment (UE) in a wireless communication system, comprising:
at least one transceiver; and
at least one processor operably coupled to the transceiver,
at least one memory, communicatively coupled to the at least one processor, storing instructions that, when executed by the at least one processor, cause the UE to:
receive, from a first base station, via a radio resource control (RRC) signaling, a quality of experience (QoE) measurement configuration information including information indicating QE measurement configurations applicable in an RRC_IDLE state or in an RRC_INACTIVE state,
based on the QoE measurement configuration information, continue ongoing QoE measurement collection when entering the RRC_IDLE or in the RRC_INACTIVE state, and
store QoE measurement report generated while in the RRC_IDLE or in the RRC_INACTIVE state in the UE.

22. The UE of claim 21, wherein the QoE measurement configuration information further includes at least one of:
a measurement configuration application layer identification,
a service type,
a QoE reference,
information indicating whether the QoE measurement is signaling based or management based,
an area scope, or
information related to a measurement collector entity (MCE).

23. The UE of claim 21, wherein, the instructions, when executed by the at least one processor, further cause the UE to:
when the UE moves to an RRC_CONNECTED state, transmit, to a second base station, an indication information of QoE measurement report availability,
receive, from the second base station, a request for retrieving the QoE measurement report; and
transmit, to the second base station, the QoE measurement report buffered when in the RRC_IDLE or in the RRC_INACTIVE state.

24. The UE of claim 21, wherein the QoE measurement report includes at least one of:
a measurement configuration application layer identification,
a QoE reference, or
information related to an MCE.

25. The UE of claim 22, wherein:
the service type is one of a streaming service or a VR service, and
application data for the streaming service or for the VR service is delivered via MBS broadcast service.

26. The UE of claim 21, wherein: in case of the UE in a dual connectivity,
a measurement configuration application layer identification for the QoE measurement configuration is allocated by a master node (MN), and
the measurement configuration application layer identification is indicated to the UE by the MN.

27. The UE of claim 26, wherein: in case of the UE in the dual connectivity,
a management-based QoE measurement configuration is received by a secondary node (SN) from an operations, administration and maintenance (OAM) node, and
the UE is selected by the SN based on the management-based QoE measurement configuration.

28. The UE of claim 27, wherein: in case of the UE in the dual connectivity, wherein the instructions executable by the at least one processor to further cause the UE to:
receiving, from the SN, the QoE measurement configuration, wherein:
the UE is configured to transmit the QoE measurement report to the MN,
a QoE reference and a MCE IP address are indicated by the SN to the MN, and
the QoE measurement report is determined to be forwarded from the MN directly to a MCE by the SN; and
transmitting the QoE measurement report to the MN.

29. A base station (BS) in a wireless communication system, comprising:
at least one transceiver; and
at least one processor operably coupled to the transceiver,
at least one memory, communicatively coupled to the at least one processor, storing instructions that, when executed by the at least one processor, cause the BS to:
transmit, to a user equipment (UE), via a radio resource control (RRC) signaling, a quality of experience (QoE) measurement configuration information including information indicating QoE measurement configurations applicable in an RRC_IDLE state or in an RRC_INACTIVE state, wherein:
based on the QoE measurement configuration information, the UE continues ongoing QoE measurement collection when entering the RRC_IDLE or in the RRC_INACTIVE state, and
the UE stores QoE measurement report generated while in the RRC_IDLE or in the RRC_INACTIVE state in the UE.

30. The BS of claim 29, wherein the QoE measurement configuration information further includes at least one of:
a measurement configuration application layer identification,
a service type,
a QoE reference,
information indicating whether the QoE measurement is signaling based or management based,
an area scope, or
information related to a measurement collector entity (MCE). JGP: 0502-0861 RCE with Amdt is ready for your review.
